(19) United States
(12) Patent Application Publication
(10) Pub. No.: US 2020/0307612 A1
(43) Pub. Date: Oct. 1, 2020

(54) VEHICLE CONTROL DEVICE

(71) Applicant: AISIN SEIKI KABUSHIKI KAISHA, Kariya-shi (JP)

(72) Inventors: Tomoyuki NAKAMURA, Kariya-shi (JP); Yosuke HASHIMOTO, Kariya-shi (JP)

(73) Assignee: AISIN SEIKI KABUSHIKI KAISHA, Kariya-shi (JP)

(21) Appl. No.: 16/817,761

(22) Filed: Mar. 13, 2020

(30) Foreign Application Priority Data
Mar. 29, 2019 (JP) 2019-067412

(51) Int. Cl. B60W 40/114; B60W 30/12; B62D 6/00

(52) U.S. Cl. CPC B60W 40/114; B60W 2520/14; B62D 6/005; B60W 30/12

(57) ABSTRACT

A vehicle control device causing a vehicle to travel along a target route includes: a first calculation unit calculating a yaw angle control amount that reduces a yaw angle deviation between an actual yaw angle of the vehicle and a target yaw angle corresponding to the target route; a second calculation unit calculating a lateral control amount that reduces a lateral deviation of the vehicle with respect to the target route; and a setting unit setting a first gain of the yaw angle control amount and a second gain of the lateral control amount. The setting unit reduces the first gain and increases the second gain at a current position of the vehicle as a current curvature is larger. The current curvature is a curvature of the target route corresponding to the current position or a curvature of the target route ahead of the current position.

### CROSS REFERENCE TO RELATED APPLICATIONS

This application is based on and claims priority under 35 U.S.C. § 119 to Japanese Patent Application 2019-067412, filed on Mar. 29, 2019, the entire contents of which are incorporated herein by reference.

### TECHNICAL FIELD

This disclosure relates to a vehicle control device.

### BACKGROUND DISCUSSION

A vehicle control device having a lane keeping technology to control the steering of a vehicle such that the vehicle does not depart from a traveling lane has been known. In the lane keeping technology, steering is controlled such that a lateral deviation that is a deviation between a target position and an actual position (current position) of a vehicle is reduced, for example, in a lateral direction orthogonal to the direction in which the traveling lane extends. For example, in a lane keeping assistance device described in Japanese Patent Laid-Open Publication No. 2009-234560, lateral displacement reference positions are provided on both sides in the width direction of a traveling lane, such that control is changed according to a positional relationship between a vehicle and the lateral displacement reference positions. Specifically, in the lane keeping assistance device, when the vehicle is traveling inside the lateral displacement reference positions, control is executed with priority given to reducing a yaw angle deviation. Meanwhile, when the vehicle is traveling outside the lateral displacement reference positions, control is executed with priority given to reducing a lateral deviation.

However, in the above-described lane keeping assistance device, when the traveling lane has a straight shape and the vehicle is traveling outside the lateral displacement reference positions, feedback control is performed such that the lateral deviation is preferentially reduced. In this case, acceleration is applied to an occupant in the lateral direction despite the straight shape of the traveling lane, and there is room for an improvement in terms of riding comfort.

Further, on the other hand, when the traveling lane has a curved shape and the vehicle is traveling inside the lateral displacement reference positions, feedback control is performed with emphasis on eliminating the yaw angle deviation, for example, even though the vehicle is traveling at a position close to one lateral displacement reference position. In this case, since the lateral deviation is less weighted, there is a possibility that the vehicle does not return to a target route (e.g., the center of the traveling lane), and there is a possibility of causing anxiety to the occupant. That is, this also affects the riding comfort of the occupant.

Thus, a need exists for a vehicle control device which is not susceptible to the drawback mentioned above.

### SUMMARY

A vehicle control device according to an aspect of this disclosure is a vehicle control device configured to cause a vehicle to travel along a target route, and the vehicle control device includes a first calculation unit configured to calculate a yaw angle control amount that reduces a yaw angle deviation that is a deviation between an actual yaw angle of the vehicle and a target yaw angle corresponding to the target route, a second calculation unit configured to calculate a lateral control amount that reduces a lateral deviation of the vehicle with respect to the target route, and a setting unit configured to set a first gain that is a gain of the yaw angle control amount and a second gain that is a gain of the lateral control amount, in which the setting unit reduces the first gain and increases the second gain at a current position of the vehicle as a current curvature is larger, the current curvature being a curvature of the target route corresponding to the current position or a curvature of the target route ahead of the current position of the vehicle.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a configuration diagram of a vehicle control device according to an embodiment;

FIG. 2 is a diagram illustrating a first map and a second map of the present embodiment;

FIG. 3 is a conceptual diagram for explaining gain change control of the present embodiment;

FIG. 4 is a conceptual diagram for explaining first specific control of the present embodiment;

FIG. 5 is a conceptual diagram for explaining second specific control of the present embodiment; and

FIG. 6 is a flowchart for explaining a flow of entire control of the present embodiment.

### DETAILED DESCRIPTION

Hereinafter, an embodiment disclosed here will be described with reference to the drawings. Each drawing used in the description is a conceptual diagram. Further, unless otherwise specified in this specification, a “vehicle” means a host vehicle.

### (Overall Configuration of Vehicle)

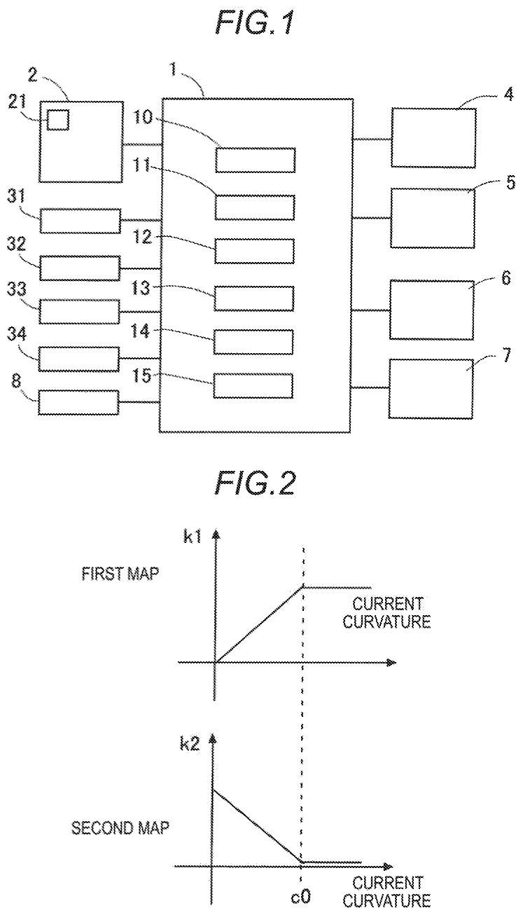

In the present embodiment, as illustrated in FIG. 1, the vehicle includes a vehicle control device 1, a periphery monitoring device 2, a wheel speed sensor 31, acceleration sensors 32 and 33, a yaw rate sensor 34, a brake control device 4, a front wheel steering angle control device 5, a rear wheel steering angle control device 6, an EPS control device 7, and a navigation device 8.

The periphery monitoring device 2 includes a camera 21 which captures an image of an area ahead of the vehicle. The periphery monitoring device 2 transmits information regarding a lane and a position of the vehicle to the vehicle control device 1 based on image data of the camera 21. A traveling lane may be specified from the image data of the camera 21 by a known method. The traveling lane is specified within an imaged range by detecting, for example, data indicating a white line on a road included in the image data. Further, the periphery monitoring device 2 calculates the curvature of the traveling lane each time the traveling lane is detected. The curvature is calculated at each predetermined interval along the center of the traveling lane. The periphery monitoring device 2 may include, for example, a stereo camera or a light detection and ranging (LIDAR) in addition to the camera 21.

The wheel speed sensor 31 is a sensor provided on each wheel to detect a wheel speed. For example, a vehicle speed may be calculated based on each wheel speed. The acceleration sensor 32 is a sensor that detects a longitudinal acceleration of the vehicle. The acceleration sensor 33 is a sensor that detects a transverse (lateral) acceleration of the vehicle. The yaw rate sensor 34 is a sensor that detects a yaw rate (actual yaw rate) of the vehicle. The information detected by the various sensors 31 to 34 is transmitted to the vehicle control device 1.

The brake control device 4 is a device that controls a braking force generated on each wheel. The brake control device 4 may adjust, for example, the hydraulic pressure of a wheel cylinder provided for each wheel to generate a different braking force for each wheel. The front wheel steering angle control device 5 is a device that controls a steering angle of front wheels. The rear wheel steering angle control device 6 is a device that controls a steering angle of rear wheels. That is, the vehicle of the present embodiment has a four wheel steering configuration in which the steering angles of all four wheels may be controlled. The EPS control device 7 is an electric power steering control device, and controls an assistance force (steering weight) for a driver's steering operation. The navigation device 8 has a GPS function capable of grasping a current position of the vehicle and map information.

### (Vehicle Control Device)

The vehicle control device 1 is a control device for causing the vehicle to travel along a target route. The vehicle control device 1 of the present embodiment is configured by an electronic control unit (ECU) including a CPU or a memory. Specifically, the vehicle control device 1 includes one or more processors, and executes various controls to be described later by an operation of the processor(s). The vehicle control device 1 includes a target route setting unit 10, a first calculation unit 11, a second calculation unit 12, a curvature acquisition unit (corresponding to an “acquisition unit”) 13, a setting unit 14, and a target value calculation unit 15.

The target route setting unit 10 sets a target route for a traveling lane based on lane information and vehicle position information transmitted from the periphery monitoring device 2. The target route setting unit 10 of the present embodiment sets the center of the traveling lane as the target route. The target route setting unit 10 stores the curvature calculated at each predetermined interval by the periphery monitoring device 2. The curvature may not be calculated by the periphery monitoring device 2 but be calculated by the target route setting unit 10.

The first calculation unit 11 calculates a yaw angle control amount which reduces a yaw angle deviation that is a deviation between an actual yaw angle of the vehicle and a target yaw angle corresponding to the target route. The actual yaw angle is an angle formed between a reference axis corresponding to the traveling lane and the longitudinal axis of the vehicle, and is calculated based on the information from the periphery monitoring device 2. The target yaw angle is a target value of the yaw angle calculated based on the target route.

The second calculation unit 12 calculates a lateral control amount which reduces a lateral deviation of the vehicle from the target route. The lateral deviation is a difference between an actual position (current position) of the vehicle and a target position that is a position of the vehicle on the target route in the lateral direction orthogonal to the target route. The actual position of the vehicle is calculated based on the information from the periphery monitoring device 2. The target position is calculated based on the information from the periphery monitoring device 2 and the target route.

The curvature acquisition unit 13 acquires a front curvature which is the curvature of the target route included in a predetermined area ahead of the vehicle from among the curvatures calculated by the periphery monitoring device 2. The predetermined area is a preset given area on the traveling lane which is set ahead of a predetermined distance from the vehicle. The predetermined area may be changed according to the vehicle speed. For example, the predetermined area may be set to a wider area as the vehicle speed is higher. Further, the predetermined area may be set to an area further forward as the vehicle speed is higher. The predetermined area may be set within an imaging range of the camera 21. Further, the predetermined area may be set based on the current position in the map information of the navigation device 8 and the like.

The curvature acquisition unit 13 acquires a front curvature from the target route setting unit 10. When the vehicle reaches a target route corresponding to the front curvature, a value acquired as the front curvature by the curvature acquisition unit 13 is set as the curvature of the target route corresponding to the current position. In the present embodiment, the curvature of the target route corresponding to the current position of the vehicle is defined as “current curvature.” The front curvature is the curvature of the target route ahead of the target route corresponding to the current curvature.

More specifically, in the present embodiment, whether or not the vehicle has reached the target route corresponding to the front curvature is determined based on the distance between the target route (predetermined area) corresponding to the front curvature and the vehicle. That is, after the front curvature is acquired, when the distance between the target route corresponding to the acquired front curvature included in the target route and the vehicle becomes equal to or less than a threshold value, the curvature acquisition unit 13 or the setting unit 14 sets a value acquired as the front curvature as the current curvature. When the threshold value is set to zero, the current curvature corresponds to the curvature of the target route of the traveling lane in which the vehicle is currently traveling. That is, when the threshold value is zero and the vehicle reaches the target route corresponding to the front curvature, the value acquired as the front curvature is set as the current curvature. Meanwhile, when the threshold value is set to a value greater than zero, the current curvature corresponds to the curvature of the target route on which the vehicle will travel from now. That is, when the threshold value is greater than zero, the current curvature is the curvature of the target route ahead of the threshold value from the current position of the vehicle. Therefore, the current curvature in this case is the curvature of the target route of the traveling lane between the traveling lane included in the predetermined area and the traveling lane in which the vehicle is currently traveling. When the threshold value is greater than zero, the threshold value is set as, for example, a value that changes according to the vehicle speed or a constant value. As described above, the current curvature is the curvature of the target route corresponding to the current position of the vehicle or the curvature of the target route ahead of the current position of the vehicle according to the setting of the threshold value. The current curvature may be set to the curvature of the target route which is included in the target route from the current position to the predetermined area. In the present embodiment, since a description is made using an example in which the threshold value is set to zero, the current curvature is the curvature of the target route corresponding to the current position of the vehicle. The function of the curvature acquisition unit 13 may be incorporated in the periphery monitoring device 2.

The setting unit 14 sets a first gain k1 which is a gain of the yaw angle control amount and a second gain k2 which is a gain of the lateral control amount. Details of the setting unit 14 will be described later.

The target value calculation unit 15 calculates a control target value at a predetermined sampling cycle based on various pieces of information. The vehicle control device 1 transmits a control instruction to at least one of the brake control device 4, the front wheel steering angle control device 5, the rear wheel steering angle control device 6, and the EPS control device 7 according to a situation based on the calculated control target value. The control target value of the present embodiment is a value corresponding to a target yaw rate. The vehicle control device 1 executes feed-forward control depending on the target yaw rate or feedback control to bring an actual yaw rate to be close to the target yaw rate.

The control target value corresponds to, for example, a total control amount obtained by summing up a yaw angle control amount obtained by multiplying a function value f(Θ) relating to the yaw angle deviation by the first gain k1, a lateral control amount obtained by multiplying a function value f(D) relating to the lateral deviation by the second gain k2, and a turning control amount obtained by multiplying a function value f(R) relating to the current turning radius of the vehicle by a third gain k3 (control target value=k1×f(Θ)+k2×f(D)+k3×f(R)). Each of the gains k1, k2, and k3 is set to a value that is equal to or greater than zero.

The function value f(R) relating to the turning radius is calculated by a formula used generally as cornering control by dividing the vehicle speed V by a value obtained by multiplying the turning radius R by an integer z1 (f(R)=V/(z1×R)). Further, the function value f(Θ) relating to the yaw angle deviation is calculated by a formula used generally in the lane keeping technology, for example, by multiplying the yaw angle deviation Θ by an integer z2 (f(Θ)=z2×Θ). Further, the function value f(D) relating to the lateral deviation is also calculated by a formula generally used in the lane keeping technology, for example, by dividing a value obtained by multiplying the lateral deviation D by an integer z3 by the vehicle speed V (f(D)=z3×D/V). From the calculated control target value, a steering angle control amount may be calculated based on, for example, the concept of a general two wheel model.

### (Gain Change Control)

The setting unit 14 reduces the first gain k1 and increases the second gain k2 at the current position as the current curvature which is the curvature of the target route corresponding to the current position of the vehicle is larger. Hereinafter, this control is also referred to as “gain change control.” It can be said that gain change control is control that increases the first gain k1 and reduces the second gain k2 at the current position as the current curvature is smaller.

The setting unit 14 stores as illustrated in, for example, FIG. 2, a first map indicating a relationship between the first gain k1 and the current curvature and a second map indicating a relationship between the second gain k2 and the current curvature. In FIG. 2, the boundary of whether the traveling lane is straight or curved may be set to c0. The current curvature corresponds to the reciprocal of the “turning radius along the target route” at the current position. In other words, “the larger the current curvature” has the same meaning as “the smaller the turning radius on the current target route.”

The setting unit 14 of the present embodiment sets the respective gains k1 and k2 based on the front curvature acquired by the curvature acquisition unit 13. That is, the setting unit 14 reduces the first gain k1 and increases the second gain k2 when the vehicle travels in the predetermined area corresponding to the front curvature as the front curvature is larger. As described above, the setting unit 14 of the present embodiment changes the first gain k1 and the second gain k2 at the current position using the front curvature acquired in advance. When the front curvature is equal to the current curvature, the respective gains k1 and k2 are kept. A process of acquiring the current curvature is not limited to the above.

In the present embodiment, the timing at which the respective gains k1 and k2 are changed is the timing at which the front curvature is recognized as the current curvature. That is, the timing at which the respective gains k1 and k2 are changed is the timing at which the vehicle travels in the predetermined area corresponding to the front curvature after the front curvature is acquired. For example, in a case of a traveling lane in which the curvature is uniformly increased like the clothoid curve, the respective gains k1 and k2 are continuously changed. The respective gains k1 and k2 may be changed gradually, for example, from the time when the front curvature is acquired to the time when the front curvature is switched to the current curvature. That is, as a result, the setting unit 14 sets the respective gains k1 and k2 such that the larger the current curvature, the smaller the first gain k1 and the larger the second gain k2 at the current position.

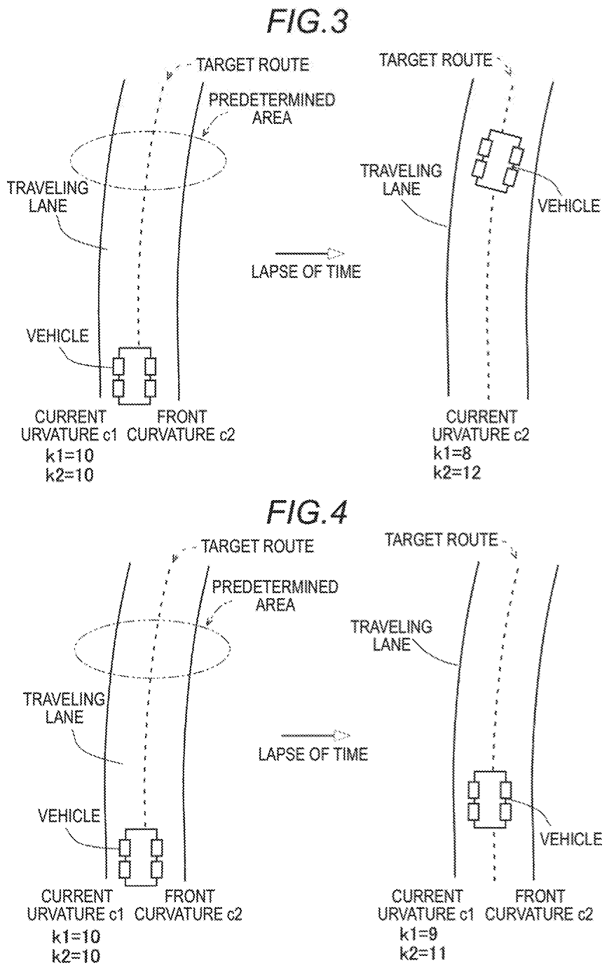

Here, the gain change control will be described using a conceptual example. For example, as illustrated in FIG. 3, it is assumed that the first gain k1 is 10 and the second gain k2 is 10 when the vehicle is traveling on a curve having a curvature c1. Thereafter, when the vehicle moves forward and travels on a curve having a curvature of c2 (c1<c2) greater than c1, for example, the first gain k1 becomes 8 and the second gain k2 becomes 12 by the gain control change of the setting unit 14. The numerical values of the gains in FIGS. 3 to 5 are numerical values for conceptual explanation.

### (First Specific Control)

When the front curvature acquired by the curvature acquisition unit 13 is larger than the current curvature, the setting unit 14 reduces the first gain and increases the second gain as the difference between the front curvature and the current curvature is larger until the vehicle reaches the target route (predetermined area) corresponding to the front curvature. Hereinafter, this control is also referred to as “first specific control,” and the difference between the front curvature and the current curvature when the front curvature is larger than the current curvature is also referred to as “curvature difference.”

When detecting that the curvature difference is equal to or greater than a predetermined value, the setting unit 14 of the present embodiment reduces the first gain and increases the second gain until the vehicle reaches the predetermined area from the detection position. When the curvature difference is equal to or greater than a predetermined value, the setting unit 14 changes, based on a change amount (correction amount) of each gain set according to the curvature difference, the respective gains k1 and k2 currently set according to the current curvature. The setting unit 14 changes the respective gains k1 and k2 by the predetermined change amount at a time until the vehicle reaches the predetermined area, or gradually changes the gains until the gains reach the predetermined change amount. The timing at which a change in the respective gains k1 and k2 in the first specific control is initiated is set to, for example, a timing at which the setting unit 14 detects (determines) that the curvature difference is equal to or greater than the predetermined value.

Here, the first specific control will be described using a conceptual example. For example, as illustrated in FIG. 4, the setting unit 14 sets the first gain k1 to 10 and the second gain k2 to 10 on a traveling lane having a curvature c1. Here, when it is detected that the curvature difference (here, the difference between c1 and c2) is equal to or greater than a threshold value while the vehicle is traveling on the traveling lane having the curvature c1, the setting unit 14 sets the first gain k1 to a value smaller than 10, and sets the second gain k2 to a value larger than 10 before the current curvature is changed to c2. In this case, for example, when it is detected that the curvature difference is equal to or greater than the threshold value, the first gain k1 is changed to a value less than 10 (e.g., the change amount=1 and k1=9) and the second gain k2 is changed to a value greater than 10 (e.g., the change amount=1 and k2=11). Then, the setting unit 14 changes the respective gains k1 and k2 after the first specific control change to the respective gains k1 and k2 corresponding to the curvature c2 when the current curvature becomes c2. In this example, the first gain k1 is reduced and the second gain k2 is increased as the curvature difference exceeds one or more set threshold values.

### (Second Specific Control)

When the direction of the target route corresponding to the front curvature acquired by the curvature acquisition unit 13 is opposite to the direction of the target route corresponding to the current curvature, the setting unit 14 reduces the first gain k1 and increases the second gain k2 until the vehicle reaches the predetermined area corresponding to the front curvature. Hereinafter, this control is also referred to as “second specific control.” The direction of a route is a turning direction of the vehicle when the vehicle travels on the route, and may be represented by clockwise and counterclockwise. Further, the direction of the route is equivalent to the direction of the target route. With regard to an arithmetic operation of the device, a plus sign is given to a counterclockwise curvature and a minus sign is given to a clockwise curvature, but the magnitude of the curvature is the magnitude of the absolute value of the curvature. The setting unit 14 determines the direction of the route based on whether the calculated curvature is a plus sign or a minus sign. As described above, the curvature acquisition unit 13 acquires the “front direction” that is the direction of the target route ahead of the target route corresponding to the current curvature. In other words, the curvature acquisition unit 13 acquires the front direction that is the direction of the target route included in the predetermined area ahead of the vehicle. Then, when the front direction acquired by the curvature acquisition unit 13 is opposite to the direction of the target route corresponding to the current position, the setting unit 14 reduces the first gain and increases the second gain until the vehicle reaches the target route corresponding to the front direction. The setting unit 14 or the curvature acquisition unit 13 may acquire information regarding the direction of the route based on the imaging data and the map information. Hereinafter, the direction of the route is also referred to as “the direction of the curvature.”

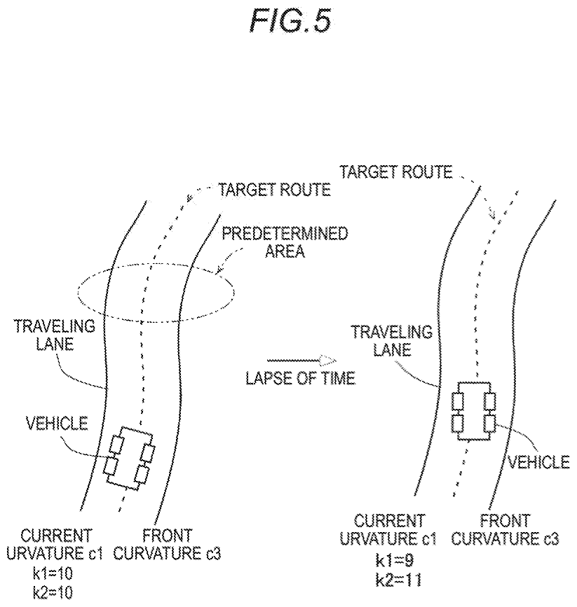

Here, the second specific control will be described using a conceptual example. For example, as illustrated in FIG. 5, when the vehicle is traveling in a lane having the curvature c1 and the curvature of the lane (front curvature c3) which bends in the opposite direction to the curvature c1 is detected, the setting unit 14 executes the second specific control. That is, before the value set as the front curvature c3 is set as the current curvature, in this example, at the timing at which it is detected that the directions of the curvatures are opposite to each other, the first gain k1 is changed to a value less than 10 (e.g., the change amount=1 and k1=9) and the second gain k2 is changed to a value greater than 10 (e.g., the change amount=1 and k1=11). Then, the setting unit 14 changes the respective gains k1 and k2 after the second specific control change to the respective gains k1 and k2 corresponding to the curvature c3 when the current curvature becomes c3. It can be said that the first specific control and the second specific control are controls of correcting the gains in a specific situation.

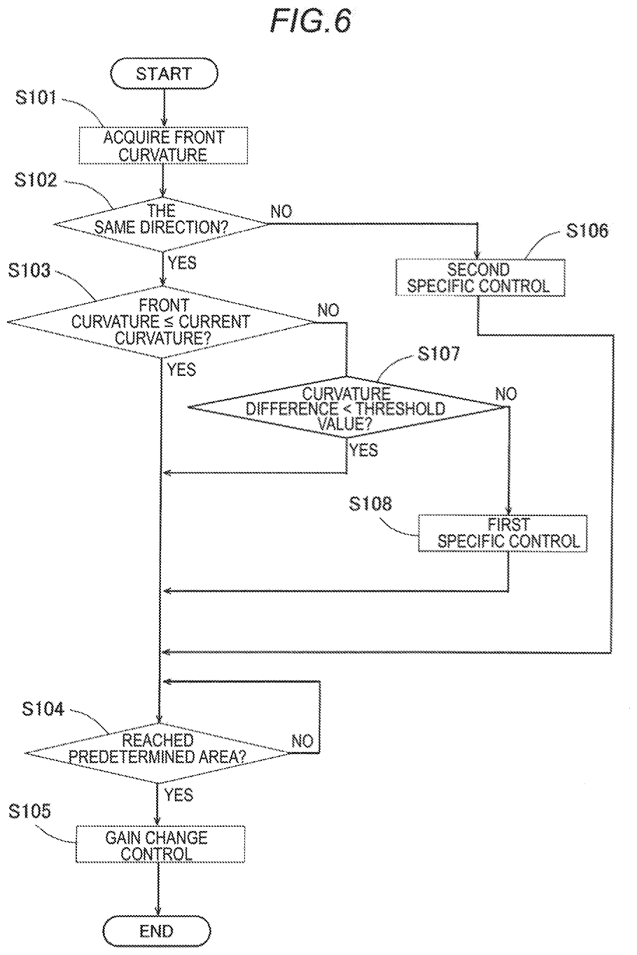

In summary, a flow of entire control regarding the gain setting of the present embodiment will be described with reference to FIG. 6. When acquiring the front curvature (S101), the vehicle control device 1 determines whether or not the direction of the current curvature and the direction of the front curvature are the same (S102). When the directions are the same (S102: YES), the vehicle control device 1 determines whether or not the front curvature is equal to or less than the current curvature (S103). When the front curvature is equal to or less than the current curvature (S103: YES), the vehicle control device 1 determines whether or not the vehicle has reached a predetermined area corresponding to the front curvature acquired in S101 (S104). When the vehicle has reached the predetermined area (S104: YES), the vehicle control device 1 recognizes the front curvature as the current curvature and executes gain change control (S105).

Meanwhile, when the direction of the current curvature is different from the direction of the front curvature (S102: NO), the vehicle control device 1 executes the second specific control (S106). After executing the second specific control, the vehicle control device 1 determines whether or not the vehicle has reached a predetermined area (S104). Further, when the front curvature is larger than the current curvature (S103: NO), the vehicle control device 1 determines whether or not the difference between the two is less than a threshold value (S107). When the difference is equal to or greater than the threshold value (S107: NO), the vehicle control device 1 executes the first specific control (S108). When the difference is less than the threshold value (S107: YES) or after executing the first specific control, the vehicle control device 1 determines whether or not the vehicle has reached the predetermined area (S104). The vehicle control device 1 repeats such control at a predetermined cycle.

### (Effects)

According to the gain change control of the present embodiment, the lane keeping control in consideration of the riding comfort of the occupant is possible by setting the respective gains k1 and k2 according to the current curvature. Specifically, as the current curvature is larger, the second gain k2 is increased and the elimination of the lateral deviation is emphasized (prioritized), and the first gain k1 is reduced and the priority of the elimination of the yaw angle deviation is lowered. In other words, as the current curvature is smaller, the first gain k1 is increased, so that the elimination of the yaw angle deviation is emphasized (prioritized). In addition, the second gain k2 is reduced, so that the priority of the elimination of the lateral deviation is lowered.

For example, when the traveling lane has a straight shape, i.e., when the current curvature is small, the second gain k2 is reduced and the lateral control amount is reduced. Thus, the lateral acceleration of the vehicle is suppressed. Since the need to travel directly above the target route is relatively low when the traveling lane has a straight shape, the riding comfort of the occupant is improved by suppressing a change in the vehicle position and suppressing lateral acceleration. Meanwhile, the traveling of the vehicle along the target route is maintained by the yaw angle control amount which has become larger and the lateral control amount which has become smaller than before the gain is changed. As described above, as the traveling lane is closer to a straight line, the stability of straight traveling is prioritized over the elimination of the lateral deviation, and the riding comfort of the occupant is improved.

Further, for example, when the curve of the traveling lane is steep, i.e., when the current curvature is large, the second gain k2 is increased and the lateral control amount is increased. Thus, priority is given to approaching the target route, and the occurrence of anxiety of the occupant during curve traveling is suppressed. As described above, when the current curvature is large, the control to more reliably suppress the vehicle from departing from the lane is executed. According to the present invention, it is possible to improve the riding comfort of the occupant while causing the vehicle to travel along the target route.

Further, according to the first specific control of the present embodiment, when the curve difference is large, the elimination of the lateral deviation is emphasized (prioritized). Thus, the position of the vehicle may approach the target route before the curve of the traveling lane becomes steep. That is, the vehicle may enter a curve having a relatively large curvature in a state where the vehicle position is close to the target route (e.g., a state where the vehicle is in the center of the lane or a state where the vehicle is near the center of the lane), so that the vehicle may more stably perform curve traveling.

Further, according to the second specific control of the present embodiment, when the front curve bends in the opposite direction to the current curve, priority is given to the elimination of the lateral deviation. Thus, the position of the vehicle may approach the target route before the vehicle enters a curve which bends in the opposite direction. That is, the vehicle may enter a curve that bends in the opposite direction in a state where the vehicle position is close to the target route, so that the vehicle may perform more stably curve traveling.

Further, in the present embodiment, since the vehicle has a four wheel steering configuration, the vehicle control device 1 may stabilize the vehicle attitude while causing the vehicle to travel along the target lane by controlling the steering angle of four wheels. Further, for example, the front wheels and the rear wheels may be controlled in the same phase or in opposite phases according to the vehicle speed. For example, when the vehicle speed is equal to or higher than a predetermined vehicle speed, the front wheels and the rear wheels are controlled in the same phase (the directions of the steering angles are the same) to stabilize the behavior of the vehicle. Meanwhile, when the vehicle speed is lower than the predetermined vehicle speed, the front wheels and the rear wheels are controlled in opposite phases (the directions of the steering angles are opposite to each other) to efficiently turn the vehicle. In the present embodiment, cornering control by the four wheel steering is executed in addition to the gain change control, the first specific control, or the second specific control. This enables more stable traveling as well as traveling along the target route.

### (Others)

The present invention is not limited to the above embodiment. In the above embodiment, after the front curvature is acquired, when the distance between the vehicle and the route corresponding to the acquired front curvature of the target route becomes equal to or less than a threshold value, the acquired value as the front curvature is currently set as the current curvature. However, the current curvature may be set in another way. For example, the periphery monitoring device 2 may calculate the respective curvatures of a first target route included in a first predetermined area ahead of the vehicle and a second target route included in a second predetermined area ahead of the first area. The curvature acquisition unit 13 may set the curvature of the first target route as the current curvature, and may set the curvature of the second target route as the front curvature.

Further, the setting unit 14 of the above embodiment uses information based on the image data of the camera 21 of the periphery monitoring device 2, but may use information of the navigation device 8 (hereinafter referred to as “navigation information”). The setting unit 14 may acquire the current curvature based on, for example, navigation information such as position information or map information included in the navigation device 8. That is, the vehicle control device 1 may acquire the current position, the current curvature, and the front curvature of the vehicle based on the navigation information and/or the information of the periphery monitoring device 2. According to the navigation information, for example, the setting unit 14 may set in advance the target route to a destination and the curvature of each of a plurality of routes included in the target route. The curvature acquisition unit 13 may acquire, for example, the curvature of a target route ahead of a predetermined distance from the current position of the vehicle (acquirable by the GPS function), i.e., the front curvature based on the navigation information. Further, the vehicle control device 1 may use map information or construction information acquired from a server via the Internet when acquiring the current curvature or the front curvature. As described above, the vehicle control device 1 may acquire the front curvature which is the curvature of the target route ahead of the target route corresponding to the current curvature by various methods.

Further, the vehicle control device 1 may be set to execute not only steering angle control but also braking force control when the control target value is equal to or greater than a threshold value. When the control target value is large, there is a high possibility that the vehicle deviates greatly from the traveling lane, and it may be determined that the urgency is high. Thus, in this case, the vehicle control device 1 controls not only the steering angle control devices 5 and 6 but also the brake control device 4 based on the control target value calculated via the gain change control. The vehicle control device 1 controls the brake control device 4, for example, such that the braking force of the wheel at the turning inner side is higher than the braking force of the wheel at the turning outer side. Thus, the vehicle turns while decelerating, so that the vehicle may approach the target route more safely.

Further, the setting unit 14 may store a map for determining a gain in the first specific control. The map may be, for example, a map in which the “current curvature” in the map of FIG. 2 is replaced with the “curvature difference” and the “gain” is replaced with the “change amount.” As described above, the change amount of the gain may be finely set according to the magnitude of the curvature difference.

Further, when executing the second specific control, the setting unit 14 may reduce the first gain k1 and increase the second gain k2 as the front curvature is larger. According to this configuration, the steeper the front curve, the more reliably the vehicle may approach the target route until the turning direction is changed. Even in this case, the setting unit 14 may store a map for determining a gain in the second specific control. The map may be, for example, a map in which the “current curvature” in the map of FIG. 2 is replaced with the “front curvature” and the “gain” is replaced with the “change amount.” Further, one or more threshold values for the front curvature for determining the change amount of the gain may be set.

Further, a predetermined area (first specific area) corresponding to the front curvature serving as an element of determining the execution of the first specific control and a predetermined area (second specific area) corresponding to the front curvature serving as an element of determining the execution of the second specific control may be set to different areas or may be set to the same area. As the first specific area is set further (farther) forward, the earlier execution of the first specific control is possible. Similarly, as the second specific area is set further (farther) forward, the earlier execution of the second specific control is possible. For example, the front curvature serving as the element of determining the execution of each control may be selected based on a preset rule from a plurality of front curvatures included in data acquired in time series via the camera 21. Further, for example, the curvature of the lane ahead of the predetermined distance from the vehicle based on the navigation information may be the element of determining the execution of each control. Further, the predetermined distance may be set for each control.

Further, in the setting of the respective gains k1 and k2, both the first specific control and the second specific control may be executed. In this case, for example, after the second specific control is executed (S106), it may be determined whether or not the front curvature is equal to or less than the current curvature (S103). When the front curvature is larger than the current curvature (S103: NO), the vehicle control device 1 determines whether or not the difference between the two is less than a threshold value (S107). When the difference is equal to or greater than the threshold value (S107: NO), the vehicle control device 1 executes the first specific control (S108). In this case, for example, the first gain and the second gain corrected by the second specific control are respectively corrected by the first specific control. Thus, control according to both the difference in the magnitude between the current curvature and the front curvature and the difference in the direction between the current route and the front route are executed. The order of the step of determining the execution of the first specific control and the step of determining the execution of the second specific control may be changed. For example, after the step S103 of determining whether or not the front curvature is equal to or less than the current curvature and the step S108 of executing the first specific control, the step S102 of determining whether or not the direction of the current curvature is the same as the direction of the front curvature may be performed.

Further, as illustrated in FIG. 2, in the first map and the second map of the present embodiment, a section (or point) where the gain becomes a first value, a section (or point) where the gain becomes a second value, and a section where the gain linearly changes between the first value and the second value are set with respect to a change in the current curvature, but this disclosure is not limited thereto. For example, the gain may change functionally (e.g., in the form of a quadratic curve) or stepwise in response to an increase in the current curvature. This is the same for the map of the first specific control or the map of the second specific control.

Further, the vehicle is not limited to the four wheel steering configuration, and may have a two wheel steering configuration. Further, various arithmetic operations may be processed with the turning radius instead of the curvature. Further, the vehicle may include various devices 4 to 8 and various sensors 31 to 34 as necessary. The technology of the present embodiment takes into consideration not only safety but also riding comfort, and is suitable not only for application to a drivers driving assistance device but also for an automatic driving vehicle.

Further, the vehicle control device 1 may not be configured to be able to execute the first specific control and the second specific control. For example, the setting unit 14 needs not to set the first gain and the second gain according to the difference between the front curvature and the current curvature. Further, the setting unit 14 does not need to set the first gain and the second gain according to the direction of the front curvature and the direction of the current curvature. Even when the first specific control and the second specific control are not executed, the setting unit 14 sets the first gain at the current position to a smaller value and sets the second gain at the current position to a larger value as the current curvature is larger. Since the vehicle control device 1 sets the first gain and the second gain according to the curvature of the traveling lane of the vehicle, the riding comfort of the occupant may be improved. Further, the vehicle control device 1 may be configured to be able to execute one of the first specific control and the second specific control in addition to the gain change control.

A vehicle control device according to an aspect of this disclosure is a vehicle control device configured to cause a vehicle to travel along a target route, and the vehicle control device includes a first calculation unit configured to calculate a yaw angle control amount that reduces a yaw angle deviation that is a deviation between an actual yaw angle of the vehicle and a target yaw angle corresponding to the target route, a second calculation unit configured to calculate a lateral control amount that reduces a lateral deviation of the vehicle with respect to the target route, and a setting unit configured to set a first gain that is a gain of the yaw angle control amount and a second gain that is a gain of the lateral control amount, in which the setting unit reduces the first gain and increases the second gain at a current position of the vehicle as a current curvature is larger, the current curvature being a curvature of the target route corresponding to the current position or a curvature of the target route ahead of the current position of the vehicle.

According to the aspect of this disclosure, each gain is changed according to the current curvature. Specifically, as the current curvature is larger, the second gain is increased and the elimination of the lateral deviation is emphasized (prioritized), and the first gain is reduced and the priority of the elimination of the yaw angle deviation is lowered. In other words, as the current curvature is smaller, the first gain is increased and the elimination of the yaw angle deviation is emphasized (prioritized), and the second gain is reduced and the priority of the elimination of the lateral deviation is lowered.

For example, when the traveling lane has a straight shape, i.e., when the current curvature is small, the second gain is reduced and the lateral control amount is reduced. Thus, a lateral acceleration of the vehicle is suppressed. Since the need to travel directly above the target route is relatively low when the traveling lane has a straight shape, the riding comfort of the occupant is improved by suppressing a change in the vehicle position and suppressing the lateral acceleration. Meanwhile, the traveling of the vehicle along the target route is maintained by the yaw angle control amount which has become larger and the lateral control amount which has become smaller than before the gain is changed. As described above, as the traveling lane is closer to a straight line, the stability of straight traveling is prioritized over the elimination of the lateral deviation, and the riding comfort of the occupant is reduced.

Further, for example, when the curve of the traveling lane is steep, i.e., when the current curvature is large, the second gain is increased and the lateral control amount is increased. Thus, priority is given to approaching the target route, and the occurrence of anxiety of the occupant during curve traveling is suppressed. As described above, when the current curvature is large, control to more reliably suppress the vehicle from departing from the lane is executed. According to this disclosure, it is possible to improve the riding comfort of the occupant while causing the vehicle to travel along the target route.

The vehicle control device may further include an acquisition unit configured to acquire a front curvature that is a curvature of the target route ahead of the target route corresponding to the current curvature, and the setting unit may reduce the first gain and increase the second gain as a difference between the front curvature and the current curvature is larger, until the vehicle reaches the target route corresponding to the front curvature when the front curvature acquired by the acquisition unit is larger than the current curvature.

The vehicle control device may further include an acquisition unit configured to acquire a front direction that is a direction of the target route ahead of the target route corresponding to the current curvature, and the setting unit may reduce the first gain and increase the second gain, until the vehicle reaches the target route corresponding to the front direction when the front direction acquired by the acquisition unit is opposite to a direction of the target route corresponding to the current position.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A vehicle control device configured to cause a vehicle to travel along a target route, the device comprising:
a first calculation unit configured to calculate a yaw angle control amount that reduces a yaw angle deviation that is a deviation between an actual yaw angle of the vehicle and a target yaw angle corresponding to the target route;
a second calculation unit configured to calculate a lateral control amount that reduces a lateral deviation of the vehicle with respect to the target route; and
a setting unit configured to set a first gain that is a gain of the yaw angle control amount and a second gain that is a gain of the lateral control amount, wherein
the setting unit reduces the first gain and increases the second gain at a current position of the vehicle as a current curvature is larger, the current curvature being a curvature of the target route corresponding to the current position or a curvature of the target route ahead of the current position of the vehicle.

2. The vehicle control device according to claim 1, further comprising:
an acquisition unit configured to acquire a front curvature that is a curvature of the target route ahead of the target route corresponding to the current curvature, wherein
the setting unit reduces the first gain and increases the second gain as a difference between the front curvature and the current curvature is larger, until the vehicle reaches the target route corresponding to the front curvature when the front curvature acquired by the acquisition unit is larger than the current curvature.

3. The vehicle control device according to claim 1, further comprising:
an acquisition unit configured to acquire a front direction that is a direction of the target route ahead of the target route corresponding to the current curvature, wherein
the setting unit reduces the first gain and increases the second gain, until the vehicle reaches the target route corresponding to the front direction when the front direction acquired by the acquisition unit is opposite to a direction of the target route corresponding to the current position.
